(19) United States
(12) Patent Application Publication
(10) Pub. No.: US 2005/0249494 A1
(43) Pub. Date: Nov. 10, 2005

(54) Photographic processor

(76) Inventors: Anthony X. Earle, Harrow Weald (GB); Bruce S. Gowans, Hemel Hempstead (GB); Peter J. Twist, Lee Common (GB); Leslie R. Wells, Bounds Green (GB)

Correspondence Address: BETH READ;PATENT LEGAL STAFF, EASTMAN KODAK COMPANY, 343 STATE STREET, ROCHESTER, NY, 14650-2201, US

(21) Appl. No.: 10/518,123

(22) PCT Filed: May 22, 2003
(86) PCT No.: PCT/EP03/05358

§ 371 Date: Jun. 20, 2005

(30) Foreign Application Priority Data
Jun. 19, 2002 (GB) 0214066.3

(51) Int. Cl. G03D 5/00

(52) U.S. Cl. 396/611

(57) ABSTRACT

A photographic processor comprises a base member in which the material is located and two side channels for holding the processing solution. Spreading means spreads the solution from one channel to another and thus across the material.

### FIELD OF THE INVENTION

This invention relates to the field of photographic processing. In particular the invention relates to a processor which uses a low volume of processing solution.

### BACKGROUND OF THE INVENTION

Conventional processing of photographic material requires the use of large tanks of processing solutions. Each tank contains a processing solution such as developer, bleach, bleach/fix, fixing solution or washing solution. The material is transported through each tank in turn. There is a tendency for the solutions to carry over from one tank to another leading to pollution of the solutions.

Conventional processing also has several other drawbacks. The temperatures which can be utilised are limited and therefore the process is slow. The composition of the solutions must be stable over long periods of time in the processing tanks. Replenishment of the solutions is also difficult to control.

To overcome the problems of conventional deep tank processing, surface application of the processing chemicals was developed. Typically, surface application methods of photographic processing involve the application of a volume of processing solution to the surface of the material being processed. However, known surface application methods have several drawbacks. For example, if the processing solution applied to the material is just left on the material in a static condition the processing will be very slow and inefficient. This is because there is no agitation and by products accumulate in the material layers and slow down the processing. Such methods are also prone to non-uniformity of processing.

### PROBLEM TO BE SOLVED BY THE INVENTION

A first problem to be solved is to spread a low volume of processing solution repeatedly over the entire surface area of the material to be processed.

A second problem to be solved is to spread the processing solution so as to avoid differential seasoning effects in differently exposed regions of the material surface. This can show up as insufficient development in neutral maximum density areas or as drag lines at dark to light exposure boundaries.

A third problem to be solved is to spread the processing solution uniformly on the material surface so that a uniform density area has no visible imperfections.

A fourth problem to be solved is to supply and contain a small volume of solution so that it can be repeatedly spread over a given length of material.

A fifth problem to be solved is to prevent “edge penetration” of processing chemicals into the cut edge of the material. This produces unacceptable visible marks along the edge of the material. This can be caused by repeated passage of a roller or such like across the edge of the material.

A sixth problem to be solved is to provide a convenient means of supplying processing solution.

### SUMMARY OF THE INVENTION

According to the present invention there is provided an apparatus for processing photographic material comprising a base member for locating the material to be processed, the base member being provided with a channel at either side thereof for holding the processing solution, and spreading means for transferring the solution from one side channel to the other, thereby spreading the solution across the material.

Preferably the side channels are shallow and curved. The base member is preferably manufactured of a heat conductive material such that the material and solution can be heated via the base member. A roller may be used to spread the solution uniformly across the material.

The invention further provides a method of processing photographic material comprising the steps of locating the material on the base member, supplying solution to at least one of the side channels and transferring the solution from one channel to the other across the material, thereby causing the solution to be spread and agitated uniformly over the material.

It is possible for the solution to be provided in two parts, one part supplied to one channel and a second part supplied to the other channel, the solution being mixed by action of the spreading means as it passes over the material. This allows solutions which are unstable over long periods to be used.

### ADVANTAGEOUS EFFECT OF THE INVENTION

The present invention provides a processor capable of spreading a low volume of processing solution repeatedly over the whole surface area of the photographic material being processed. The processing solution is spread so as to avoid differential seasoning effects in differently exposed regions of the material surface. The movement of the solution from one side channel to the other effectively mixes the solution and prevents these seasoning effects. Repeatedly moving the processing solution from one channel to the other also achieves uniform spreading of the solution so as to result in a uniform density area having no visible imperfections.

The side channels can be conveniently accessed by the roller. The side channels also provide improved solution management over known processors. It is easier to provide the channels with solution than to apply direct onto the paper. It is also easier to mix the solutions within the channels. The invention can be used in both single use/single sheet mode and in continuous mode. The processor does not require conventional deep tanks and has no standing solutions.

Due to the low volumes of solution used and the fact that no deep tanks are required it is possible for RX (Redox amplification) chemistry to be used as well as conventional chemistry. The invention allows solutions to be run close to exhaustion which is not possible in conventional processors. Thus the method of the invention can provide much lower chemical usage rates. The invention can accommodate any process for colour paper, reversal paper or black and white paper. The process can be changed on demand and it is therefore easy to change from one chemical process to another, e.g. from colour to black and white processing.

The processor unit is also cheap and easy to manufacture.

### BRIEF DESCRIPTION OF THE DRAWINGS

The invention will now be described, by way of example, with reference to the accompanying drawings, in which:

FIG. 1 is a schematic cross sectional view of a processor according to the invention;

FIG. 2 is a schematic cross sectional view of one end of another processor according to the invention;

FIG. 3 is a schematic side view of a driving mechanism;

FIG. 4 is an end view of the driving mechanism shown in FIG. 3; and

FIGS. 5 to 8 are graphs illustrating the sensitometric results obtained from a processor according to the present invention in comparison with results obtained from a reference conventional processor.

### DETAILED DESCRIPTION OF THE INVENTION

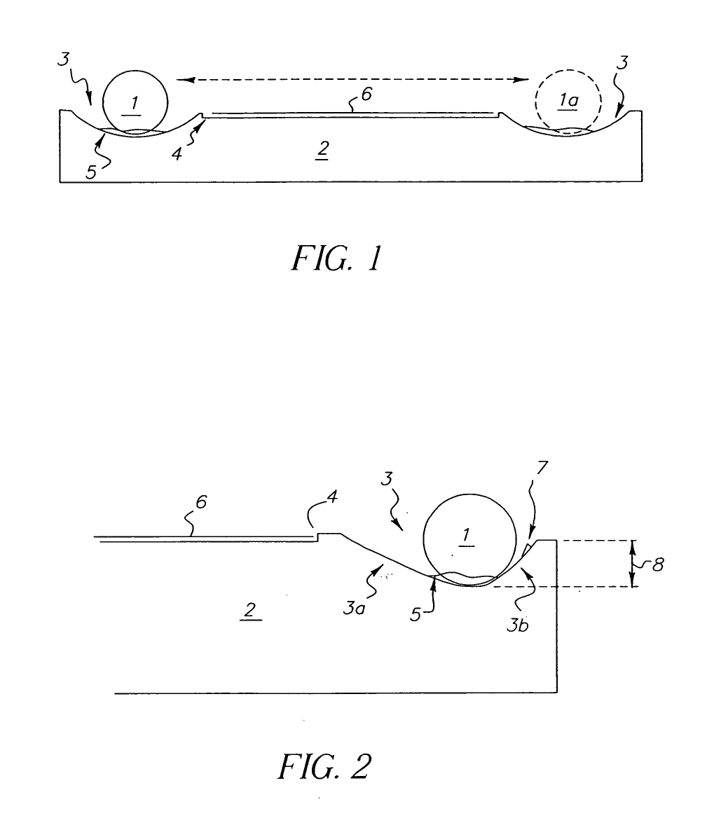

FIG. 1 is a schematic cross sectional view of a side channel processor according to the invention. To simplify the drawing no drive mechanism for the rollers is shown or any means of loading the material to be processed is shown in this figure.

The processor comprises a base member 2 having a shallow curved side channel 3 at either side thereof A roller 1 is provided for movement from one side channel 3 to the other. This is illustrated by the same roller in position 1a.

The base member 2 is manufactured from a heat conductive material such as stainless steel. However, other non corroding metals can be used as can conductive plastics and carbon fibre materials. The base member is heated. The solution and paper are thus heated via the base member. This is advantageous since the solution could be unstable and problems may arise if it is heated prior to use. The curved side channels 3 contain processing solution. A recess 4 is provided at the top of the base member. The material to be processed is located in this recess. The recess has a depth slightly greater than the thickness of the material 6 to be processed, hereinafter referred to as paper. This recess prevents the problems of “edge penetration” of the processing solution into the edges of the paper. Edge penetration produces unacceptable visible marks along the edge of the paper which may be caused by repeated passage of the roller over the edge of the paper. The recess 4 extends to just over the width of the paper so that the roller 1 does not strike the edge of the paper as it moves out of the side channel 3.

The arrangement shown in FIG. 1 can have open ended side channels 3. Alternatively the side channels 3 can be provided with an end stop at both ends to contain the processing solution. Alternatively there can be an end stop on one end of the side channel and an open end at the other end so that used solution can flow out of the open end to drain.

The processing solution is moved from one channel to another and thus across the surface of the paper by means of the roller. Those skilled in the art will recognise that other means may be used, such as, for example only, a squeegee, a pad, or an air knife. Movement of the roller across the paper spreads the low volume of solution repeatedly and uniformly over the whole surface area of the paper. The movement of the solution from one side channel to the other effectively mixes the solution and prevents seasoning effects.

The arrangement shown in FIG. 1 has a contour of constant curvature for the side channels. In practice it has been found that it is preferable to provide a shallow slope on the inner side of the channel and a steeper slope on the outer side of the channel. This is illustrated in FIG. 2 which shows just one of the two side channels 3. The base member 2 again has a recess 4 for the paper 6. The roller 1 is shown in the right hand side channel 3 which has a shallow curvature 3a on the inner side of the channel and a steeper curvature 3b on the outer side of the channel. The curvature 3a is smooth such that the roller follows the surface and does not jump over the edge. A raised rib member 7 is provided on the outer side of the channel 3. It is advantageous to have two rib members on the outer side of each channel. The rib members 7 prevent processing solution being trapped behind the roller 1. The rib members lift the roller 1 as it moves outwards and allow solution to run back down into the side channel 3.

The depth 8 of the side channel 3 can be anything that is convenient but typically it has been used at 5 mm. The depth 8 will depend on the dimensions of the paper or film that is to be processed. For a large width of paper the channel will need to be deeper to accommodate sufficient processing solution. A range of channel depth 8 from 1 mm to 50 mm would cover most applications but any convenient depth can be used.

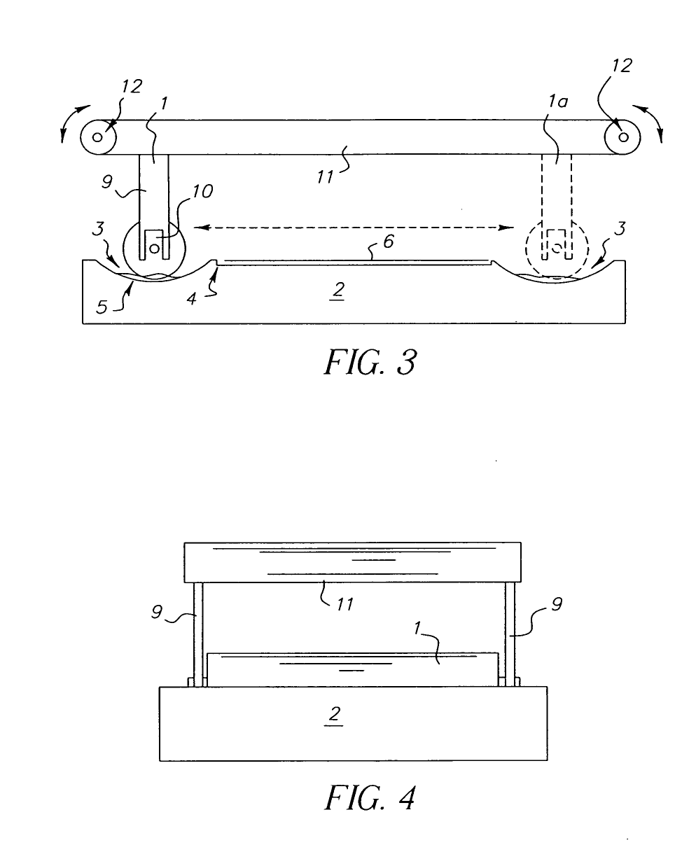

FIG. 3 is a schematic side view of a driving mechanism for the processor.

In FIG. 3 the roller 1 is shown mounted on supports 9 which are attached to a belt 11. The roller 1 is held in a yoke 10 which allows the roller 1 to run over the paper 6 and accommodate the different heights. The belt 11 is driven by drive rollers 12. These drive rollers can move the belt in either direction to move the roller 1 to position 1a and back.

FIG. 4 illustrates an end view of the mechanism as shown in FIG. 3.

In operation processing solution 5 is added to the side channels 3. The volume of solution is very small, just enough to allow processing of the paper. Advantageously the solution is metered into the channel. The solution can be added initially to only one side channel 3 and is subsequently moved by the roller 1 between the side channels 3. Alternatively the processing solution 5 can be added to both side channels 3 at the start and is then collected and mixed by the roller 1 as it moves between the two side channels 3. If necessary the processing solution 5 can be the same in both side channels 3 or there can be a different processing solution 5 in one side channel 3 compared with the other. For example a developer solution can be made from two parts and one part is added to one side channel 3 and the other part to the second side channel 3. The active developer composition is then made by the mixing action of the roller 1 as it moves across the paper 6. The side channels thus provide a convenient place to add fresh processing solution, a temporary storage region for processing solution and a place where the roller can collect fresh solution. The roller moves back and forth from one side channel 3 to the other at a rate of between 0.1 and 5 cycles per second.

Solution 5 is moved by the roller 1 over the paper and into the second side channel and back again. On the outward path the roller 1 encounters the raised ribs 7 which lift the roller 1 and release solution 5 back into the side channel 3.

The roller can be moved continuously from one side channel to the other side channel for the entire time of the process stage. Alternatively the roller can be moved intermittently with a dwell time in one or both of the side channels. In another method of use the roller can be moved continuously for the initial part of the process stage and then stopped in one of the side channels and the process stage allowed to become complete without any further movement of the roller. If the paper can then be moved onto a second application stage for the next part of the process cycle then a second print can be developed in the first application stage as soon as the first print is out of the way. This method is shown in example 2 which will be described later.

### EXAMPLE 1

In this example photographic paper was exposed to a sensitometric test object and then processed in the side channel processor. Sensitometric exposures were also made and processed in a reference deep tank processor with which to compare the experimental process. It is part of the invention to use the side channel processor for rapid processing and to demonstrate this a short development time of 20 seconds was examined. This is shorter than the reference process which is 45 seconds. It is also a purpose of the invention to process in single-use mode with only a small amount of processing solution. The reference process was run in 2 litre tanks which were replenished with 9 ml/sq.ft or 96.8 ml/sq.m. The side channel processor does not have any processing solution in the channel at the start. Instead, the solution is added just prior to processing of the paper. The amount of processing solution used is equal to the replenishment rate of the reference process which is 9 ml/sq.ft or 96.8 ml/sq.m for the developer.

In this example samples of photographic paper are processed in an apparatus as described above. The process cycle used is shown in Table 1. The bleach-fix is made from a standard commercial kit of Kodak™ Ektacolor Prime™ Bleach-Fix and Replenisher. The developer composition used is shown in Table 2.

TABLE 1
Process Cycle

| Side Channel Process | | Reference Process |
|---|---|---|
| Develop | 20 seconds | 45 seconds |
| Bleach-fix | 45 seconds | 45 seconds |
| Wash | 90 seconds | 90 seconds |

The development stage was completed in the side channel processor but the bleach-fix and wash stages were completed in conventional tanks after the removal of the paper from the side channel processor.

The developer composition used in the reference process was Kodak Ektacolor™ SP made from a standard commercial kit. The experimental developer composition was as follows;

TABLE 2
Developer Composition

| Potassium carbonate | 33 | g/l |
|---|---|---|
| diethyl hydroxylamine(85%) | 5 | g/l |
| CD3 | 10 | g/l |
| pH | 10.6 | |
| Tween 80 | 1 | g/l |

| | |
|---|---|
| Temperature | 38° C. |

Where CD3 is N-[2-(4-amino-N-ethyl-m-toluidino)ethyl]-methanesulphonamide sesquisulphate hydrate and Tween 80 is polyoxyethylene(20) sorbitan monooleate.

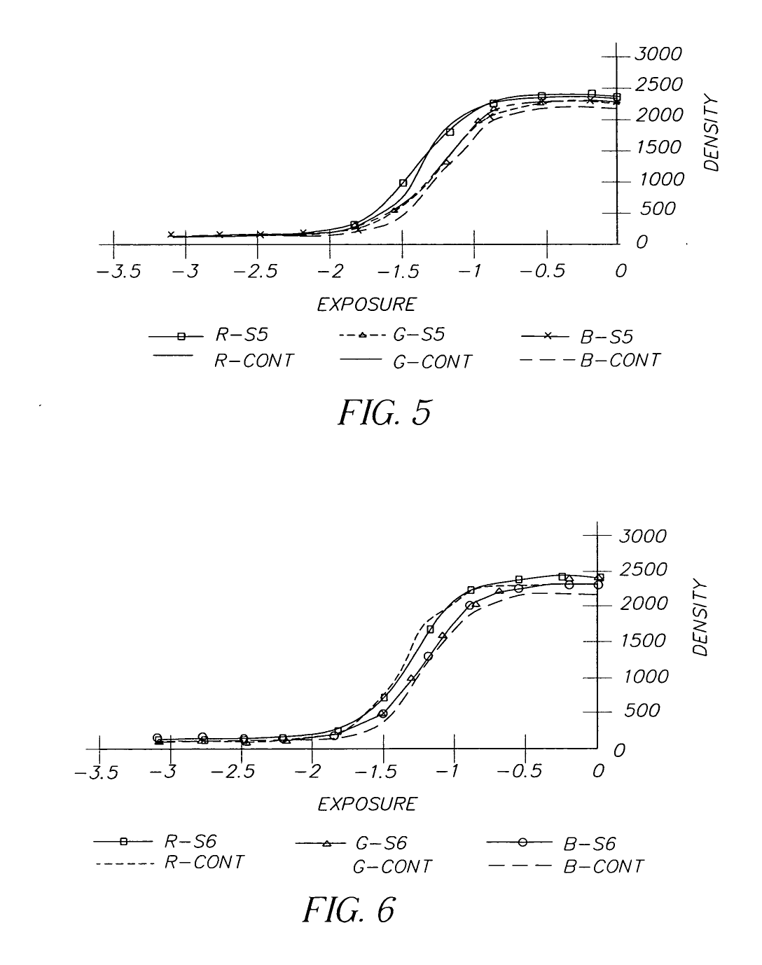

A comparison with the reference process is shown in FIG. 5 where DENSITY is reflection density×1000.

It can be seen from FIG. 5 that the experimental process is close to the reference process.

A second process was carried out in which the developer solution residue left in the side channel from the previous process was not removed and a new developer solution added on top of it. Otherwise this was the same as in described above. The result is shown in FIG. 6.

Again it can be seen that the experimental process is close to the reference process.

### EXAMPLE 2

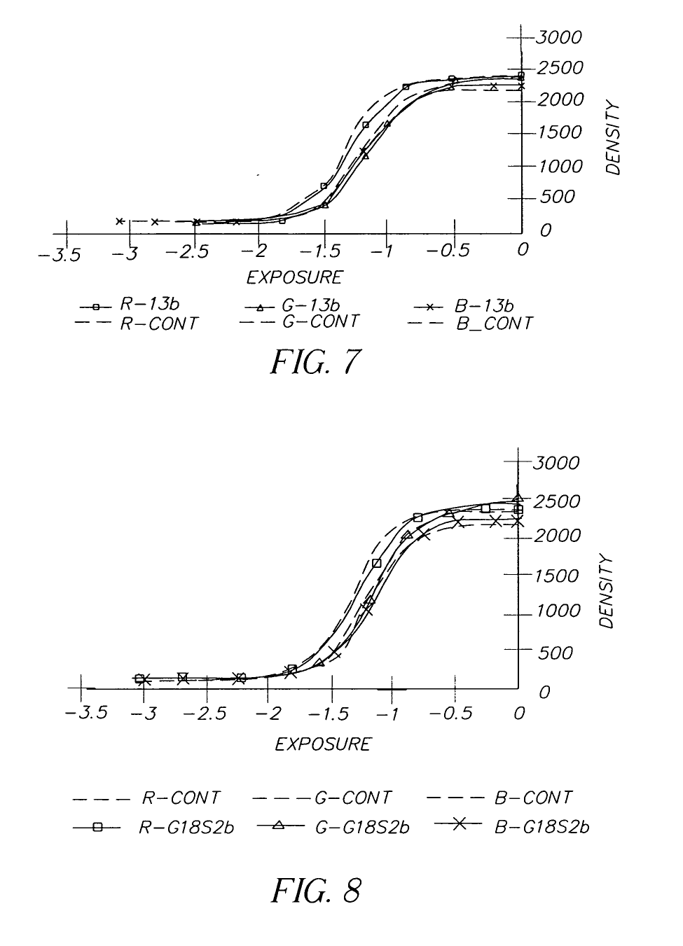

In this example the developer is applied and agitated on the surface of the paper for only a part of the total development time. The remaining part of the development time is completed with the paper left in position but without any movement of the roller and hence no further agitation or developer application. In order to obtain a close match to the reference process the total time of development was increased from 20 to 25 seconds. The process cycle was otherwise as in Table 1 and the bleach-fix and wash were carried out in conventional tanks after removing the paper from the side channel processor. The developer composition was as in Table 2. The result is shown in FIG. 7.

### EXAMPLE 3

In this example the developer was made in two parts. One part contained the colour developing agent plus a small amount of sodium sulfite and the other the rest of the components. The composition of the two parts is shown in Table 3.

TABLE 3
Two Part Developer

| | Part 1 | | Part 2 | |
|---|---|---|---|---|
| Potassium carbonate | 66 | g/l | — | |
| diethyl hydroxylamine(85%) | 10 | g/l | — | |
| CD3 | 0 | g/l | 20 | g/l |
| sodium sulfite | 0 | | 0.5 | g/l |
| pH | 11.74 | | 1.76 | |
| Phorwite REU | 4 | g/l | — | |
| Tween 80 | 1 | g/l | 1 | g/l |

| | | |
|---|---|---|
| Temperature | 38° C. | 38° C. |

where phorwite REU is a commercially available stain reducing agent. The final pH of a mixture of equal parts of 1 and 2 is pH 10.6.

0.75 ml of part 1 of the developer was placed in one channel and 0.75 ml of part 2 of the developer was placed in the other channel. The roller was started in the channel containing part 1 of the developer and moved over the paper into the channel containing part 2 of the developer and then back over the paper into the channel containing part 1. This was repeated for the whole development time of 20 seconds. The paper was bleach-fixed and washed in separate tanks. The result is shown in FIG. 8.

The whole process cycle may take place in the processor unit of the invention. The process cycle may be develop, stop, bleach, fix and wash. The processing solution for each stage is added to the channels and repeatedly spread across the material by the roller. Any remaining solution is then removed and the next solution added to the channels. It is also possible to have a series of similar units in which a different stage of the process takes place in each. It is also possible for the any one or more of the stages of the process to take place in a processor unit according to the invention and for the rest of the process to be carried out in conventional processors. The process is easy to adapt as the cycle times are not fixed.

The invention is equally applicable to colour paper, reversal paper or black and white paper. It works equally well with 35 mm and APS. It is equally applicable for conventional or redox amplification processing.

The invention is designed primarily to be used in single use mode but it can also be used in batch mode. In single use mode the processing solution is discarded after use as the chemicals are exhausted. In batch mode solutions can be withdrawn from a reservoir, used to process within the side channel processor, removed from the processor and then returned to the reservoir. Single use mode is the method normally employed in the invention.

The invention has been described in detail with reference to preferred embodiments thereof. It will be understood by those skilled in the art that variations and modifications can be effected within the scope of the invention.

### PARTS LIST

1. roller

2. base member

3. side channel

4. recess

5. solution

6. material

7. rib member

8. depth of channel

9. support

10. yoke

11. belt

12. drive roller

1. Apparatus for processing photographic material comprising a base member for locating the material to be processed, the base member being provided with a channel at either side thereof for holding the processing solution, and spreading means for transferring the solution from one side channel to the other, thereby spreading the solution across the material.

2. Apparatus as claimed in claim 1 wherein the side channels are shallow.

3. Apparatus as claimed in claim 2 wherein the depth of the channels is between 1 mm and 50 mm.

4. Apparatus as claimed in claim 1 wherein the side channels are provided with one or more rib members on the wall remote from the base member.

5. Apparatus as claimed in claim 1 wherein the channels are curved.

6. Apparatus as claimed in claim 5 wherein the curve on the side remote to the base member has a steeper slope than that on the side closest to the base member.

7. Apparatus as claimed in any preceding claim wherein a roller spreads the solution across the material.

8. Apparatus as claimed in claim 1 wherein a pad spreads the solution across the material.

9. Apparatus as claimed in claim 1 wherein an air knife spreads the solution across the material.

10. Apparatus as claimed in any preceding claim wherein the base member is made of a heat conductive material.

11. Apparatus as claimed in any preceding claim wherein the base has a recess in which the material is located, the recess having a depth slightly greater than the thickness of the material.

12. A method of processing photographic material comprising the steps of locating the material on the base member, supplying solution to at least one of the side channels and transferring the solution from one channel to the other across the material, thereby causing the solution to be spread and agitated uniformly over the material.

13. A method as claimed in claim 12 wherein the processing solution is metered into the channels.

14. A method as claimed in claim 12 wherein a two part solution has a first part supplied to one channel and a second part supplied to the other channel, the solution being mixed by action of the spreading means as it passes over the material.

15. A method as claimed in claim 12, wherein the solution and the material are heated by heating the base member, the base member being pre-heated.

16. A method as claimed in claim 12 wherein the solution is spread across the material by means of a roller.

17. A method as claimed in claim 12 wherein the solution is spread across the material by means of a pad.

18. A method as claimed in claim 12 wherein the solution is spread across the material by means of an air knife.

19. A method as claimed in claim 12 wherein every stage of the entire process cycle is performed with the material located in the base member by sequentially adding and removing processing solutions for a given stage followed by the adding and removing the processing solutions for the next stage and so on to complete the entire process cycle.

20. A method as claimed in claim 12 wherein the process is customized to suit any particular material.

21. A photographic processing system comprising a first processor according to claim 1 arranged to receive photographic material and perform a first processing stage on the material and at least one additional processor according to claim 1 arranged to receive photographic material from the first processor, the at least one additional processor being arranged to perform one or more subsequent processing stages on the material.
